(19) United States
(12) Patent Application Publication
(10) Pub. No.: US 2024/0019305 A1
(43) Pub. Date: Jan. 18, 2024

(54) SYSTEM AND METHOD FOR FAULT DETECTION AND OPERATIONAL READINESS FOR OPTICAL INSTRUMENTS FOR SEMICONDUCTOR PROCESSES

(71) Applicant: Verity Instruments, Inc., Carrollton, TX (US)

(72) Inventors: Andrew Weeks Kueny, Carrollton, TX (US); Mike Whelan, Carrollton, TX (US)

(21) Appl. No.: 18/352,058

(22) Filed: Jul. 13, 2023

Related U.S. Application Data
(60) Provisional application No. 63/389,498, filed on Jul. 15, 2022.

(51) Int. Cl. G01J 3/28

(52) U.S. Cl. CPC G01J 3/28

(57) ABSTRACT

The disclosure recognizes that it is better to not start monitoring a controllable process than to monitor that process with an optical instrument, such as a process controlling instrument/sensor, when that optical instrument is not operating properly. Accordingly, the disclosure relates to novel features for checking that an optical instrument, such as a spectrometer, is working properly before being used to monitor a semiconductor process. In one aspect the disclosure provides a system for evaluation and verification of an operational state of an optical instrument. In one example, the system includes: (1) an integrated light source, (2) an optical sensor for collecting light from the integrated light source, (3) a controller controlling the integrated light source and the optical sensor, and (4) a processor for processing collected optical signal data obtained from the light and deriving a metric indicative of the operational state.

### CROSS-REFERENCE TO RELATED APPLICATION

This application claims the benefit of U.S. Provisional Application Ser. No. 63/389,498, filed by Andrew Weeks Kueny, et al., on Jul. 15, 2022, entitled “System and Method for Fault Detection and Operational Readiness for Optical Instruments for Semiconductor Processes”, which is commonly assigned with this application and incorporated herein by reference in its entirety.

### TECHNICAL FIELD

This disclosure relates, generally, to optical spectroscopy systems and methods of use, and more specifically, to fault detection and readiness for use of optical instruments used for monitoring of semiconductor processes.

### BACKGROUND

Optical monitoring of semiconductor processes is a well-established method for controlling processes such as etch, deposition, chemical mechanical polishing and implantation. Optical emission spectroscopy (OES) and interferometric endpoint (IEP) are two basic types of modes of operation for data collection. In OES applications light emitted from the process, typically from plasmas, is collected and analyzed to identify and track changes in atomic and molecular species which are indicative of the state or progression of the process being monitored. In IEP applications, light is typically supplied from an external source, such as a flashlamp, and directed onto a workpiece. Upon reflection from the workpiece, the sourced light carries information, in the form of the reflectance of the workpiece, which is indicative of the state of the workpiece. Extraction and modeling of the reflectance of the workpiece permits understanding of film thickness and feature sizes/depth/widths among other properties.

### SUMMARY

In one aspect, the disclosure provides a system for evaluation and verification of an operational state of an optical instrument. In one example, the system includes: (1) an integrated light source, (2) an optical sensor for collecting light from the integrated light source, (3) a controller controlling the integrated light source and the optical sensor, and (4) a processor for processing collected optical signal data obtained from the light and deriving a metric indicative of the operational state.

In another aspect, the disclosure provides a method of evaluating the operational state of an optical instrument. In one example the method of evaluating includes: (1) obtaining a difference spectrum from differential optical spectra obtained under different illumination conditions of an integrated light source of the optical instrument, and (2) analyzing the difference spectrum to derive a metric indicative of the operational state.

In yet another aspect, the disclosure provides a computer program product having a series of operating instructions stored on a non-transitory computer readable medium that directs the operation of one or more processors when initiated thereby to perform operations. In one example, the operations include: (1) obtaining a test difference spectrum from differential optical spectra obtained under different illumination conditions of an integrated light source of an optical instrument, and (2) analyzing the test difference spectrum by comparing the test difference spectrum to a reference difference spectrum, wherein the test difference spectrum is obtained after manufacturing of the optical instrument and the reference difference spectrum is obtained during manufacturing of the optical instrument.

In still yet another aspect, the disclosure provides a spectrometer. In one example the spectrometer includes: (1) an optical sensor, (2) an integrated light source positioned to illuminate the optical sensor, and (3) one or more processors that perform operations, the operations including performing a functional evaluation of the spectrometer by operating the integrated light source and processing differential optical spectra data that corresponds to the integrated light source being on and the integrated light source being off.

### BRIEF DESCRIPTION OF THE DRAWINGS

Reference is now made to the following descriptions taken in conjunction with the accompanying drawings, in which:

FIG. 1 is a block diagram of a system for employing OES and/or IEP to monitor and/or control the state of a plasma or non-plasma process within a semiconductor process tool;

FIG. 2 is block diagram of a spectrometer and specific related systems, in accordance with this disclosure;

FIG. 3 is a plot of typical OES and IEP optical spectra which may be incident upon an optical instrument during a semiconductor process, in accordance with this disclosure;

FIG. 4 is plot of representative spectra of light sources which may be used for optical instrument testing, in accordance with this disclosure;

FIG. 5 is a plot of representative spectra of illuminated and dark test data, in accordance with this disclosure;

FIG. 6 is a plot of representative difference spectra of test data, in accordance with this disclosure;

FIG. 7 is a flow chart of an example method of fault detection and readiness testing for an optical instrument in accordance with this disclosure; and

FIG. 8 illustrates an example of a computing device that is configured to perform a functional health evaluation of an optical instrument according to the principles of the disclosure.

### DETAILED DESCRIPTION

In the following description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following description is, therefore, not to be taken in a limiting sense. For clarity of exposition, like features shown in the accompanying drawings are indicated with like reference numerals and similar features as shown in alternate embodiments in the drawings are indicated with similar reference numerals. Other features of the present invention will be apparent from the accompanying drawings and from the following detailed description. It is noted that, for purposes of illustrative clarity, certain elements in the drawings may not be drawn to scale.

The constant advance of semiconductor processes toward faster processes, smaller feature sizes, more complex structures, larger wafers, and more complex process chemistries places great demands on process monitoring technologies. For example, higher data rates are required to accurately monitor much faster etch rates on very thin layers where changes in Angstroms (a few atomic layers) are critical such as for fin field-effect transistor (FINFET) and three dimensional NAND (3D NAND) structures. Wider optical bandwidth and greater signal-to-noise are required in many cases both for OES and IEP methodologies to aid in detecting small changes either/both for reflectances and optical emissions. Cost and packaging sizes are also under constant pressure as the process equipment becomes more complex and costly itself. All of these requirements seek to advance the performance of optical monitoring of semiconductor processes. Regardless, if for OES or IEP methodologies, the ability of optical instruments to reliably, consistently and accurately convert received optical data to electrical data is an important aspect for control and monitoring of semiconductor processes.

The high cost of semiconductor processes, the high value of semiconductor wafers, and the safety requirements for processing place stringent demands upon the optical instruments used for monitoring and controlling such processes. As such, the evaluation and verification of readiness of optical instruments to monitor or control semiconductor processes is a critical function and can include detailed evaluation of multiple subsystems of an optical instrument. Spectrometers, monochromators, and other optical devices that process multiple wavelengths of light are examples of optical instruments used for monitoring of semiconductor processes. In various examples provided herein, a spectrometer is used as a non-limiting example of an optical instrument.

The disclosure recognizes that it is better to not start monitoring a controllable process than to monitor that process with a spectrometer, as a process controlling instrument/sensor, when that spectrometer is not operating properly. Accordingly, the disclosure relates to novel features for checking that a spectrometer is working properly before being used to monitor a semiconductor process. The novel features can be implemented in a method, system, and computing device as disclosed in the examples provided herein. For example, the disclosed method includes a differential test that uses a known light source to determine the operating functionality of a spectrometer. The known light source is a stable and controllable light source (e.g., can be turned on and off and/or be adjusted in intensity) that is positioned to illuminate the sensor of a spectrometer. The controllable light source can be positioned to directly illuminate the sensor or not. The controllable light source can be inserted (or partially inserted) within the spectrometer or positioned external to the spectrometer. Integrated as used herein referring to the controllable light source includes being positioned internal, external, or partly internal/external with respect to the spectrometer. The controllable light source, also referred to herein as an integrated light source, can be a light emitting diode (LED), an incandescent source, or another type of light source that can be differentially controlled (e.g., can be turned on and off and/or be adjusted in intensity). A green LED is used as an example of a controllable light source in various examples disclosed herein.

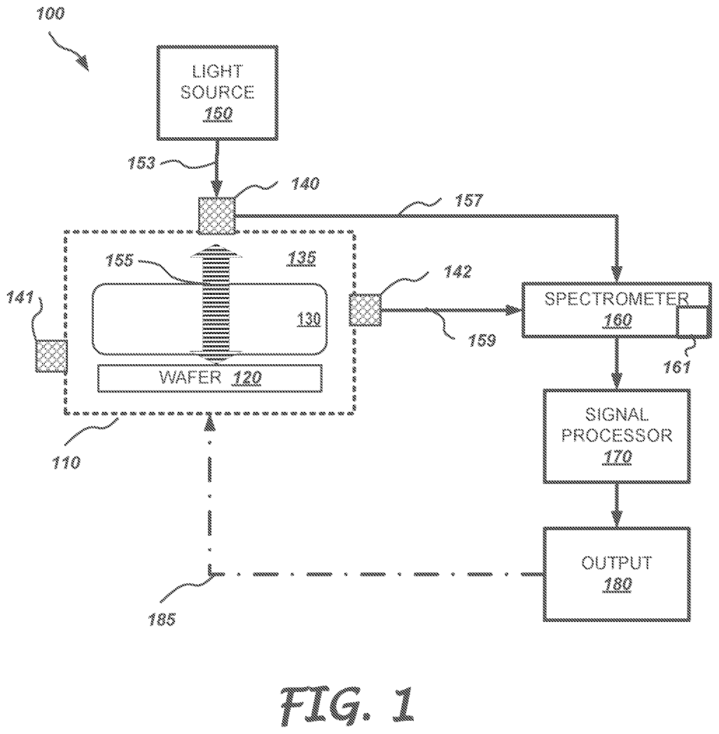

With specific regard to monitoring and evaluating the state of a semiconductor process within a process tool, FIG. 1 illustrates a block diagram of an example process system 100 utilizing OES and/or IEP to monitor and/or control the state of a plasma or non-plasma process within a semiconductor process tool 110. Semiconductor process tool 110, or simply process tool 110, generally encloses wafer 120 and possibly process plasma 130 in a typically, partially evacuated volume of a chamber 135 that may include various process gases. Process tool 110 may include one or multiple optical interfaces, or simply interfaces, 140, 141 and 142 to permit observation into the chamber 135 at various locations and orientations. Interfaces 140, 141 and 142 may include multiple types of optical elements such as, but not limited to, optical filters, lenses, windows, apertures, fiber optics, etc.

For IEP applications, light source 150 may be connected with interface 140 directly or via fiber optical cable assembly 153. As shown in this configuration, interface 140 is oriented normal to the surface of wafer 120 and often centered with respect to the same. Light from light source 150 may enter the internal volume of chamber 135 in the form of collimated beam 155. Beam 155 upon reflection from the wafer 120 may again be received by interface 140. In common applications, interface 140 may be an optical collimator. Following receipt by interface 140, the light may be transferred via fiber optic cable assembly 157 to spectrometer 160 for detection and conversion to digital signals. The light can include sourced and detected light and may include, for example, the wavelength range from deep ultraviolet (DUV) to near-infrared (NIR). Wavelengths of interest may be selected from any subrange of the wavelength range. For larger substrates or where understanding of wafer non-uniformity is a concern, additional optical interfaces (not shown in FIG. 1) normally oriented with the wafer 120 may be used. The processing tool 110 can also include additional optical interfaces positioned at different locations for other monitoring options.

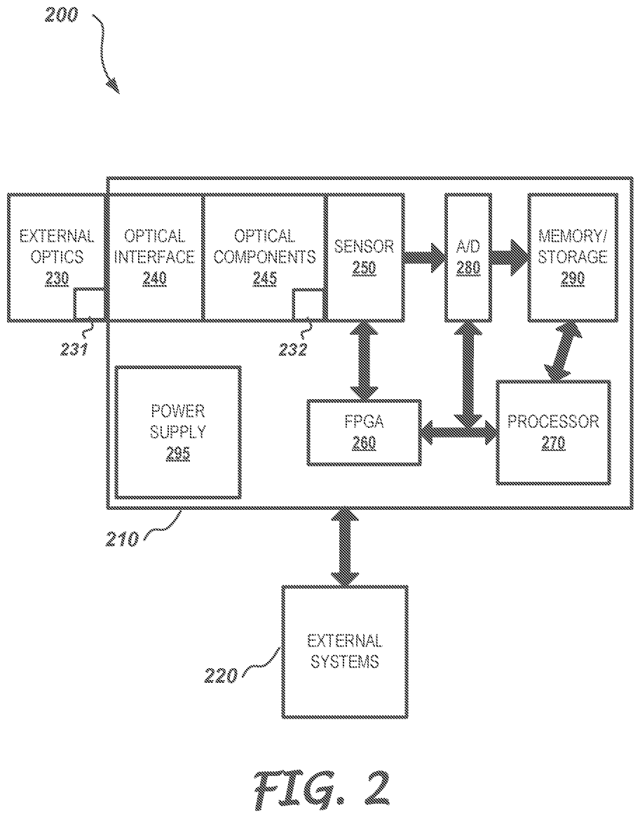

For OES applications, interface 142 may be oriented to collect light emissions from plasma 130. Interface 142 may simply be a viewport or may additionally include other optics such as lenses, mirrors and optical wavelength filters. Fiber optic cable assembly 159 may direct any collected light to spectrometer 160 for detection and conversion to digital signals. The spectrometer 160 can include a CCD sensor and convertor for the detection and conversion. Sensor 250 of FIG. 2 provides an example of a sensor that can be used with the spectrometer 160. Multiple interfaces may be used separately or in parallel to collect OES related optical signals. For example, interface 141 may be located to collect emissions from near the surface of wafer 120 while interface 142 may be located to view the bulk of the plasma 130, as shown in FIG. 1.

In many semiconductor processing applications, it is common to collect both OES and IEP optical signals and this collection provides multiple problems for using spectrometer 160. Typically OES signals are continuous in time whereas IEP signals may be either/both continuous or discrete in time. The mixing of these signals causes numerous difficulties as process control often requires the detection of small changes in both the OES and IEP signals and the inherent variation in either signal can mask the observation of the changes in the other signal. It is not advantageous to support multiple spectrometers for each signal type due to, for example, cost, complexity, inconvenience of signal timing synchronization, calibration and packaging.

After detection and conversion of the received optical signals to analog electrical signals by the spectrometer 160, the analog electrical signals are typically amplified and digitized within a subsystem of spectrometer 160, and passed to signal processor 170. Signal processor 170 may be, for example, an industrial PC, PLC or other system, which employs one or more algorithms to produce output 180 such as, for example, an analog or digital control value representing the intensity of a specific wavelength or the ratio of two wavelength bands. Instead of a separate device, signal processor 170 may alternatively be integrated with spectrometer 160. The signal processor 170 may employ an OES algorithm that analyzes emission intensity signals at predetermined wavelength(s) and determines trend parameters that relate to the state of the process and can be used to access that state, for instance end point detection, etch depth, etc. For IEP applications, the signal processor 170 may employ an algorithm that analyzes wide-bandwidth portions of spectra to determine a film thickness. For example, see System and Method for In-situ Monitor and Control of Film Thickness and Trench Depth, U.S. Pat. No. 7,049,156, incorporated herein by reference. Output 180 may be transferred to process tool 110 via communication link 185 for monitoring and/or modifying the production process occurring within chamber 135 of the process tool 110.

The shown and described components of FIG. 1 are simplified for expedience and are commonly known. In addition to common functions, the spectrometer 160 or the signal processor 170 can also be configured to identify stationary and transient optical and non-optical signals and process these signals according to the methods and/or features disclosed herein. As such, the spectrometer 160 or the signal processor 170 can include algorithms, processing capability, and/or logic to identify and process optical signals and temporal trends extracted therefrom. The algorithms, processing capability, and/or logic can be in the form of hardware, software, firmware, or any combination thereof. The algorithms, processing capability, and/or logic can be within one computing device or can also be distributed over multiple devices, such as the spectrometer 160 and the signal processor 170. The spectrometer 160, the signal processor 170, or a combination thereof can also be configured to perform the additional function of initiating or controlling a functional health evaluation as disclosed herein. Accordingly, algorithms, processing capability, and/or logic can be within one computing device, such as the spectrometer 160, or can also be distributed over multiple devices, for performing the functional health evaluation. For example, operating instructions according to at least some of the steps of method 700 can be stored on one or more devices, such as a memory associated with the spectrometer 160, a memory associated with the signal processor 170, or distributed therebetween, for the evaluation and verification of the operational state of the spectrometer 160. Spectrometer 210 of FIG. 2 provides an example of one of the devices wherein the operating instructions can be stored. As such, process system 100 also includes a controllable light source such as disclosed herein that is integrated with spectrometer 160. Controllable light source 161 provides an example of such an integrated light source to illuminate (either directly or indirectly) the sensor of the spectrometer 160. Controllable light source 161 is positioned within the spectrometer 160. An example of a controllable light source that is positioned external to a spectrometer is controllable light source 231 shown in FIG. 2.

FIG. 2 is a block diagram of an example optical system 200 including a spectrometer 210 and specific related systems, in accordance with the principles of the disclosure. Spectrometer 210 may incorporate the system, features, and methods disclosed herein to the advantage of measurement, characterization, analysis, and processing of optical signals from semiconductor processes and may be associated with spectrometer 160 of FIG. 1. Spectrometer 210 may receive optical signals from external optics 230, such as via fiber optic cable assemblies 157 or 159, and may, following integration and conversion, send data to external systems 220, such as output 180 of FIG. 1, which may also be used to control spectrometer 210 by, for example, selecting a mode of operation or controlling integration timing as defined herein. The external optics 230 can include a controllable light source, such as represented by controllable light source 231. Alternatively, a controllable light source 232 may be more specifically integrated with spectrometer 210 by appropriate placement with respect to optical components 245. Spectrometer 210 may include optical interface 240 such as a subminiature assembly (SMA) or ferrule connector (FC) fiber optic connector or other opto-mechanical interface. The opto-mechanical interface controls the orientation of the fiber array relative to the input of the spectrometer so that the CCD read procedure may accurately isolate the respective channels. Further optical components 245 such as slits, lenses, filters and gratings may act to form, guide and chromatically separate the received optical signals and direct them to sensor 250 for integration and conversion.

Low-level functions of sensor 250 may be controlled by elements such as FPGA 260 and processor 270. Following optical to electrical conversion, analog signals may be directed to A/D convertor 280 and converted from electrical analog signals to electrical digital signals which may then be stored in memory 290 for immediate or later use and transmission, such as to external systems 220 (c.f., signal processor 170 of FIG. 1). Spectrometer 210 also includes a power supply 295, which can be a conventional AC or DC power supply typically included with spectrometers.

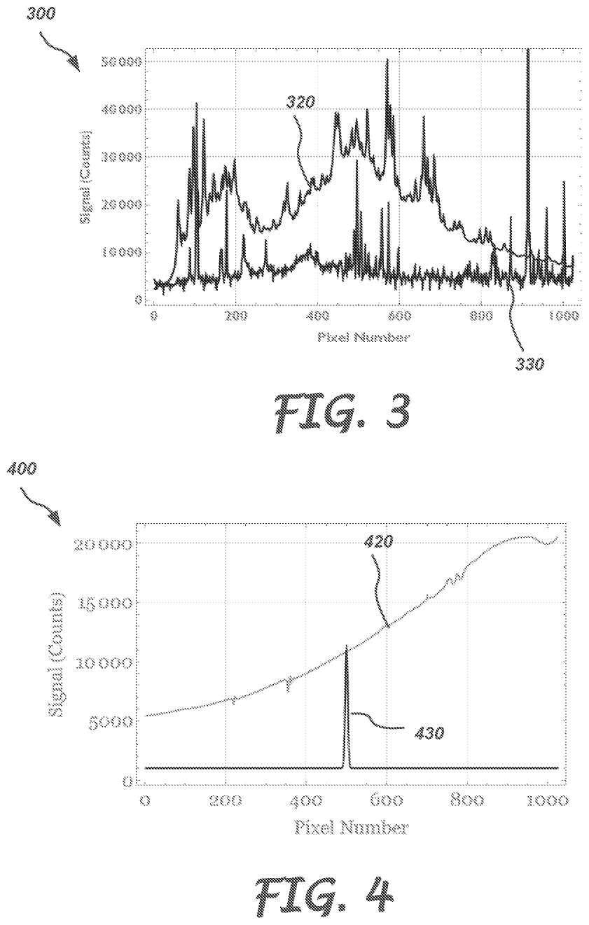

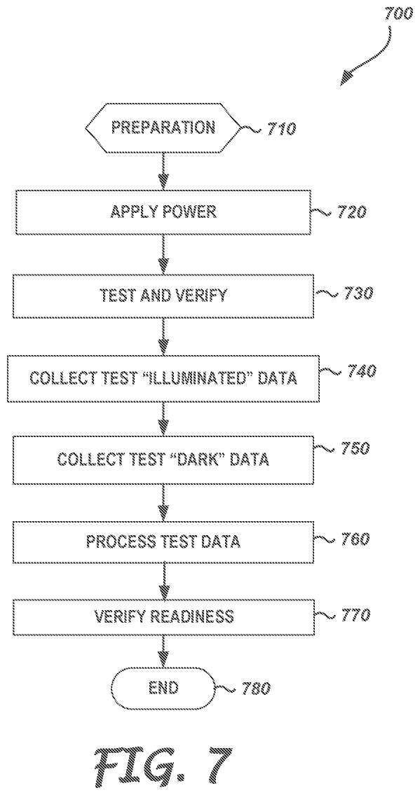

Although certain interfaces and relationships are indicated by arrows, not all interactions and control relations are indicated in FIG. 2. Spectral data shown in FIGS. 3-5 may be, for example, collected, stored and/or acted upon, according to process 700 of FIG. 7 and within or by one or multiple of memory/storage 290, FPGA 260, processor 270 and/or external systems 220. Memory/storage 290, FPGA 260, processor 270, and/or external systems 220 provide examples wherein the processing capability, logic, and/or operating instructions corresponding to algorithms for initiating or controlling a functional health evaluation as disclosed herein can be stored. The spectrometer 210

For a functional health evaluation and verification of process readiness, multiple functionalities of an optical instrument are individually or in-combination tested. These subsystems and functionalities include, but are not limited to, main power supplies, system I/O power supplies, processor power supplies, FPGA power supplies, processor boot functionality, FPGA boot functionality, system clock operation, Ethernet or other connectivity link, A/D power supplies, A/D data path operation, PPI port data functionality, basic CCD clocking operations, data integration time functionality, cooling fan operation, operating temperature verification, accessory light source availability and operational status, and optical signal noise signatures. In one or more example, multiple of the functionalities must be tested. Additionally, certain functionalities may not be evaluated and verified without knowledge of an optical signal which may be used as a reference. Examples of optical signal sources which may provide a reference optical signal include controllable light sources 231 and 232, light source 150, and/or plasma 130. These sources may be used individually, sequentially or in combination to provide optical signals useful for functional evaluation of an optical instrument. These functionalities include, but are not limited to, functionality of CCD power supplies, clock driver operation, and CCD signal chain components.

As one primary functionality of an optical instrument is to collect, process, and transmit optical data to a semiconductor control system, the disclosure recognizes that an appropriately designed functional test may suffice to evaluate and verify a significant portion of the subsystems described above, even under the potential of variable incident optical illumination. FIG. 3 provides plot 300 of typical OES (spectrum 330) and IEP (spectrum 320) optical spectra which may be incident upon an optical instrument, such as spectrometer 160 or 200 of FIG. 1 or 2, during a semiconductor process. As such, spectrum 320 and spectrum 330 represent incident light that is expected and provides illumination of the sensor during monitoring and taken into account when determining process readiness of the optical instrument. Since an optical instrument, such as spectrometer 160, is integrated with system 100 which also controls the creation of plasma (resulting in, for example, spectrum 330) and/or indirectly operation of light source 150 (resulting in, for example, spectrum 320); the optical instrument can determine to perform or be directed to perform functional evaluation when spectra 320 or spectra 330 are not being provided, created, and received by the optical instrument. An optical instrument may also be subject to less-controlled or less-controllable ambient light from one or more other sources such as incandescent, LED, and fluorescent lighting outside of the processing system. Ambient light, for example, can enter the process chamber 135 via optical interface 141 and be incident upon the sensor of spectrometer 160. Differentiating between illumination of the sensor by the expected incident light, such as spectra 320 and spectra 330, and illumination due to unintended light, such as ambient light, can be beneficial.

The integration of a stable and controllable light source with an optical instrument supports the collection of differential optical spectra which avoids the issues with variable illumination and supports evaluation of at least multiple if not all of the subsystems described above. The differential optical spectra are optical spectra that are obtained under different illumination conditions such as 1) when the controllable light source is on and 2) when the controllable light source is off. The differential optical spectra are processed to obtain a difference spectrum. Processing can include calculating the simple difference between various spectra as discussed herein. The resultant difference spectrum is then representative of the response of the optical instrument to the controlled light source and not subject to uncontrolled ambient and external optical sources. Changes between a reference difference spectrum collected and stored at a time of manufacture and any subsequently collected difference spectrum may provide indications of the state or degree of process readiness of the optical instrument. A test difference spectrum used herein is an example of a difference spectrum collected post manufacturing. Alternatively or additionally to comparisons to a reference difference spectrum, comparisons may be made between two or more subsequently collected different spectra. For example, a difference spectrum obtained at initial set-up of the optical instrument compared to a difference spectrum obtained a certain amount of time or number of processes monitored after initial set-up. Such post-manufacturing difference spectra and comparisons may provide various indications regarding operational variation and drift of the optical instrument.

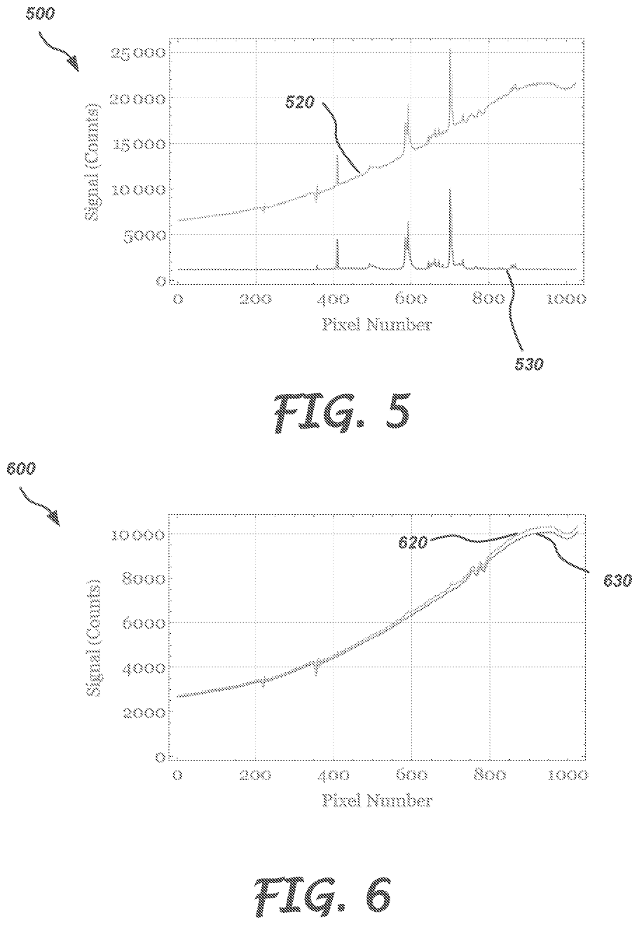

Plot 300 of FIG. 3 has an x-axis in wavelength units and a y-axis of signal count units. FIGS. 4, 5, and 6 also have an x-axis in wavelength units and a y-axis of signal count units. FIG. 4 illustrates representative spectra of light sources which may be used for optical instrument testing. FIG. 5 provides examples of optical spectra 520 and 530 that can be processed to determine a difference spectrum and FIG. 6 provides examples of difference spectra 620 and 630.

FIG. 4 shows plot 400 that includes the representative spectra of light sources, trace 420 and trace 430, which may be used for optical instrument testing. Trace 420 represents a spectrum of an optical source, such as a LED, that is located within an optical instrument such that it directly illuminates an optical sensor, such as a CCD. Therefore, due to the direct illumination specific spectral information is not available. Trace 430 represents another spectrum of the same LED, for example a green or red LED, except located within the optical instrument such that the spectral character of the source is apparent. An LED may be located within the optical path of the instrument such that chromatic separation of light occurs such as in advance of a grating or prism. One possible benefit of locating the light source where spectral characteristics may be determined, e.g., not positioned to directly illuminate the sensor, is that optical spectral wavelength calibration may be more readily evaluated. An additional benefit of providing a narrow-band light source where it may be chromatically characterized is that the resultant spectra include specific wavelength regions (relating to specific physical regions of an optical sensor) where light will be predetermined to either exist or be excluded (i.e., there are illuminated and dark regions of a sensor such as sensor 250 of FIG. 2 or sensor 160 of FIG. 1).

FIG. 5 shows plot 500 of spectrum 520 collected with an integrated light source directly illuminating the CCD and spectrum 530 with an integrated light source not illuminating the CCD. In both spectra 520 and 530, ambient fluorescent light is present. Spectrum 520 and 530 may be collected during manufacturing and stored for later reference (e.g., comparisons) or may be collected at some subsequent time. Spectrum 530 may be subtracted from spectrum 520 to provide a difference spectrum such as spectra 620 and 630 or FIG. 6.

FIG. 6 shows plot 600 of a reference difference spectrum 620 and a test difference spectrum 630 collected at some time later after manufacturing. It may be seen that both of the difference spectra 620 and 630 generally exclude the ambient light signals and that the difference spectra indicate only small differences over time. Reference difference spectrum 620 can be determined during manufacturing (e.g., such as from spectrum 520 and 530) and stored for later reference (e.g., comparisons) after manufacturing. Differences spectra 630 may be collected at any convenient time such as at regular intervals as part of a readiness check.

FIG. 7 is a flow chart of a method 700 of use of fault detection and readiness testing for an optical instrument. At least some of the steps of the method 700 can be carried out by one or more processors, such as a computing device as disclosed herein. Method 700 starts with a preparation step 710 wherein any preparatory actions may be taken which may include selection of predetermined optical signal collection parameters.

In step 720, power may be applied to an optical instrument. Similarly, a warm or cold boot of the instrument may achieve an equivalent initial condition. Subsequent to step 730 one or more of the functionalities described herein may be evaluated. For example, boot functionality may be evaluated and verified in cooperation with a connected external system that expects a “ready” message signifying that an optical instrument is communicating. Internally an optical instrument may evaluate and verify the expected operation of other functionalities and archive that information internally or transmit it to an externally connected system such as semiconductor process tool 110 of FIG. 1. Any individual or group of functionalities may be evaluated and verified and severities, such as warning, error and fault, may be defined based upon the outcomes of individual or group evaluations. For example, an indication of a non-operational fan may be grouped with an in-range indication of operating temperature and the optical instrument may be classified as “ready” although an adverse indication is presented. Evaluations and verifications may be performed in hardware and/or in software stored and acting within one or more subsystems of, for example, spectrometer 210 of FIG. 2.

Functional evaluation and verification may be performed as a portion of process 700 starting with step 740 wherein an integrated light source is configured to illuminate an optical sensor within an optical instrument. With the integrated light source providing an optical signal, one or more spectra (first portion of differential optical signal) may be collected and stored for use. Collection parameters such as integration time, sampling rate, and number of samples may be predetermined in accord to functionalities to be evaluated such as noise characteristics and signal levels. In step 750 the second portion of the differential optical signal data may be collected with the integrated light source not providing an optical signal. Steps 740 and 750 may be performed in any order. In step 760, the spectral data collected during steps 740 and 750 may be processed to define a difference spectra and additionally processed to extract one or more readiness metrics. A readiness metric, or simply metric, may include comparison of a currently collected difference spectrum (e.g., 630) with a reference difference spectrum (e.g., 620) that was stored upon initial fabrication or manufacturing of the optical instrument. Spectral data comparison may include thresholding of differences between current and reference spectra, range verification of the average value of the ratio of the current and reference spectra (e.g., average ratio is ideally 1.0 but may be in-range with a predetermined range of 0.9-1.1). Spectral comparison may also include calculation of a correlation coefficient between the current and reference spectra. When current and reference spectra are configured to provide wavelength information as with trace 430 of FIG. 4, an autocorrelation parameter may be calculated between the current and reference spectra to determine any wavelength calibration shift as a readiness metric. Additionally, information provided by a trace such as trace 430 may be analyzed for stray light and background signal drift as readiness metrics. If noise or signal-to-noise evaluation are to be performed and provided as readiness metrics, spectral data may be collected at multiple integration times or optical signal levels. In step 770, a readiness or non-readiness state may be determined from the one or more performed evaluations and verification and such status may be transmitted to an external system, such as a processing tool (e.g. 110) or one of external systems 220. If readiness is not verified, a semiconductor process may be prohibited from starting until operational readiness of the optical instrument can be verified. Any readiness metric or combinations thereof can be used to verify readiness. As noted above, one or more readiness metric can be derived different ways. For example, a readiness metric can be compared to a predetermined threshold to determine readiness or not for the optical instrument. Specifically, a spectral comparison correlation readiness metric may be required to be greater than 0.9 but less than 1.1 indicating limited changes in spectral intensity drift. Furthermore, a spectral calibration readiness metric may be required to less than the absolute value of 0.2 nm to indicate limited changes in calibration drift. Method 700 ends with step 780.

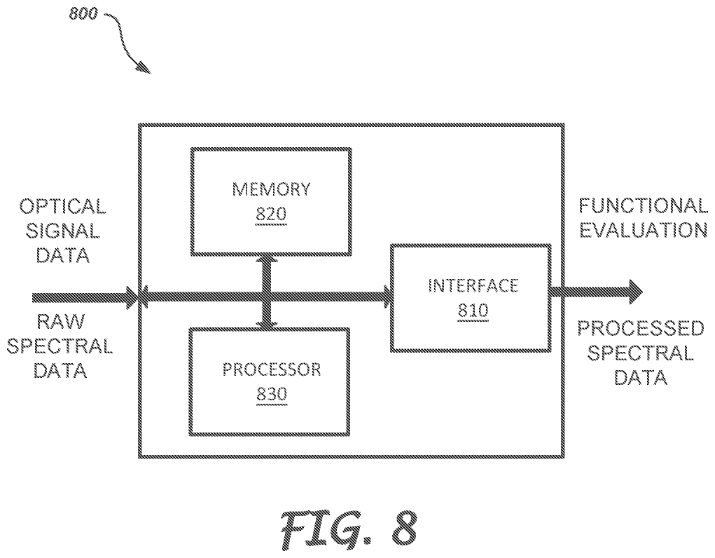

An integrated light source may be controlled and synchronized with spectral data collection by an integrated processing or control component such as FPGA 260 or processor 270 of FIG. 2. FPGA 260, processor 270, and memory 290 may be used as a composite computing device that can also be used for processes disclosed herein, such as collecting spectral data and processing signals including optical signal data from the integrated light source. The computing device may also include other elements of spectrometer 210 and may include external systems 220 in a distributed computation system. The computing device may include at least one interface (as shown by arrows in FIG. 2), one or more memory (such as represented by memory 290 of FIG. 2) and one or more processor (such as represented by FPGA 260 or processor 270 of FIG. 2). FIG. 8 illustrates an example of a computing device 800 that includes at least one interface 810, one or more memory, and one or more processors. Memory 820 represents one or more memory and processor 830 represents one or more processors. The interface 810 includes the necessary hardware, software, or combination thereof to receive, for example, raw spectral data and to transmit, for example, processed spectral data. The interface 810 can also receive optical signal data from an integrated light source and transmit the results of a functional evaluation based on the optical signal data from the integrated light source. The processor 830 can be configured to operate the integrated light source from which the optical signal data is generated. The processor 830 can operate the integrated light source when the raw spectral data is not being received for processing. A portion of the interface 810 can also include the necessary hardware, software, or combination thereof for communicating analog or digital electrical signals. The interface 810 can be a conventional interface that communicates via various communication systems, connections, busses, etc., according to protocols, such as standard protocols or proprietary protocols (e.g., interface may support I2C, USB, RS232, SPI, or MODBUS). The memory 820 is configured to store the various software and digital data aspects related to the computing device. Additionally, the memory 820 is configured to store a series of operating instructions corresponding to an algorithm or algorithms that direct the operation of the processor 830 when initiated to, for example, identify anomalous signals in spectral data and process identified anomalous signals. The processing may include removing or modifying the signal data or a different action. For example, the series of operating instructions can direct the processor 830 (or processors) to control or direct differential functional testing to determine the health of a spectrometer. The process 700 and variations thereof being representative examples of algorithms used to verify the health of an optical instrument such as a spectrometer. The memory 820 can be a non-transitory computer readable medium (e.g., flash memory and/or other media).

The processor 830 is configured to direct the operation of the computing device 800. As such, the processor 830 includes the necessary logic to communicate with the interface 810 and the memory 820 and perform the functions described herein for health evaluation and to identify and process anomalous signals in spectral data. For example, the processor 830 can generate a readiness metric and provide the metric to the interface 810 for delivery, wherein the readiness metric can represent the functional evaluation of an optical instrument. A portion of the above-described apparatus, systems or methods may be embodied in or performed by various, such as conventional, digital data processors or computers, wherein the computers are programmed or store executable programs of sequences of software instructions to perform one or more of the steps of the methods. The software instructions of such programs or code may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein.

Portions of disclosed embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter. Configured means, for example, designed, constructed, or programmed, with the necessary logic, algorithms, processing instructions, and/or features for performing a task or tasks.

The changes described above, and others, may be made in the optical measurement systems and subsystems described herein without departing from the scope hereof. For example, although certain examples are described in association with semiconductor wafer processing equipment, it may be understood that the optical measurement systems described herein may be adapted to other types of processing equipment such as roll-to-roll thin film processing, solar cell fabrication or any application where high precision optical measurement may be required. Furthermore, although certain embodiments discussed herein describe the use of a common light analyzing device, such as an imaging spectrograph, it should be understood that multiple light analyzing devices with known relative sensitivity may be utilized. Furthermore, although the term “wafer” has been used herein when describing aspects of the current invention, it should be understood that other types of workpieces such as quartz plates, phase shift masks, LED substrates and other non-semiconductor processing related substrates and workpieces including solid, gaseous and liquid workpieces may be used.

The embodiments described herein were selected and described in order to best explain the principles of the invention and the practical application, and to enable others of ordinary skill in the art to understand the invention for various embodiments with various modifications as are suited to the particular use contemplated. The particular embodiments described herein are in no way intended to limit the scope of the present invention as it may be practiced in a variety of variations and environments without departing from the scope and intent of the invention. Thus, the present invention is not intended to be limited to the embodiment shown, but is to be accorded the widest scope consistent with the principles and features described herein.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects all generally referred to herein as a “circuit” or “module.” Furthermore, the present invention may take the form of a computer program product on a computer-usable storage medium having computer-usable program code embodied in the medium.

Various aspects of the disclosure can be claimed including the apparatuses, systems, and methods disclosed herein. Aspects disclosed herein and noted in the Summary include:

A. A system for evaluation and verification of an operational state of an optical instrument, including: (1) an integrated light source, (2) an optical sensor for collecting light from the integrated light source, (3) a controller controlling the integrated light source and the optical sensor, and (4) a processor for processing collected optical signal data obtained from the light and deriving a metric indicative of the operational state.

B. A method of evaluating the operational state of an optical instrument, including: (1) obtaining a difference spectrum from differential optical spectra obtained under different illumination conditions of an integrated light source of the optical instrument, and (2) analyzing the difference spectrum to derive a metric indicative of the operational state.

C. A computer program product having a series of operating instructions stored on a non-transitory computer readable medium that directs the operation of one or more processors when initiated thereby to perform operations, the operations including: (1) obtaining a test difference spectrum from differential optical spectra obtained under different illumination conditions of an integrated light source of an optical instrument, and (2) analyzing the test difference spectrum by comparing the test difference spectrum to a reference difference spectrum, wherein the test difference spectrum is obtained after manufacturing of the optical instrument and the reference difference spectrum is obtained during manufacturing of the optical instrument.

D. A spectrometer including: (1) an optical sensor, (2) an integrated light source positioned to illuminate the optical sensor, and (3) one or more processors that perform operations, the operations including performing a functional evaluation of the spectrometer by operating the integrated light source and processing differential optical spectra data that corresponds to the integrated light source being on and the integrated light source being off

Each of aspects A, B, C, and D can have one or more of the following additional elements in combination: Element 1: wherein the integrated light source is a controllable light source that can be turned on and turned off. Element 2: wherein the integrated light source is at least partially located within the optical instrument. Element 3: wherein the collected optical signal data includes data collected when the integrated light source is on and when the integrated light source is off. Element 4: wherein the processing includes verifying the optical sensor is responding to light generated by the integrated light source. Element 5: wherein the processing includes generating a test difference spectrum from the collected light and comparing the test difference spectrum to a reference different spectrum, wherein the test difference spectrum is obtained after manufacturing of the optical instrument and the reference difference spectrum is obtained during manufacturing. Element 6: wherein the integrated light source is an LED. Element 7: wherein the processor is further configured to perform or direct functional testing of one or more sub-system of the optical instrument. Element 8: wherein the optical instrument is a spectrometer. Element 9: wherein the difference spectrum is a test difference spectrum obtained after manufacturing and the analyzing includes comparing the test difference spectrum to a reference difference spectrum obtained during manufacturing. Element 10: wherein the comparing includes thresholding of differences between the test difference spectrum and the reference difference spectrum. Element 11: wherein the comparing includes verifying a range of an average value of a ratio of the test difference spectrum and the reference difference spectrum. Element 12: wherein the comparing includes calculating a correlation coefficient between the test difference spectrum and the reference difference spectrum. Element 13: wherein both the test difference spectrum and the reference difference spectrum provide wavelength information and the comparing includes determining a wavelength calibration shift therebetween by calculating an autocorrelation parameter between the test difference spectrum and the reference difference spectrum. Element 14: further comprising conducting one or more individual functional tests directed to specific sub-subsystems of the optical instrument. Element 15: further comprising generating and sending a readiness or non-readiness state for the optical instrument based on analyzing one of the one or more individual functional tests. Element 16: wherein the optical instrument is a spectrometer.

What is claimed is:

1. A system for evaluation and verification of an operational state of an optical instrument, comprising:
an integrated light source;
an optical sensor for collecting light from the integrated light source;
a controller controlling the integrated light source and the optical sensor; and
a processor for processing collected optical signal data obtained from the light and
deriving a metric indicative of the operational state.

2. The system as recited in claim 1, wherein the integrated light source is a controllable light source that can be turned on and turned off.

3. The system as recited in claim 1, wherein the integrated light source is at least partially located within the optical instrument.

4. The system as recited in claim 1, wherein the collected optical signal data includes data collected when the integrated light source is on and when the integrated light source is off.

5. The system as recited in claim 1, wherein the processing includes verifying the optical sensor is responding to light generated by the integrated light source.

6. The system as recited in claim 1, wherein the processing includes generating a test difference spectrum from the collected light and comparing the test difference spectrum to a reference different spectrum, wherein the test difference spectrum is obtained after manufacturing of the optical instrument and the reference difference spectrum is obtained during manufacturing.

7. The system as recited in claim 1, wherein the integrated light source is an LED.

8. The system as recited in claim 1, wherein the processor is further configured to perform or direct functional testing of one or more sub-system of the optical instrument.

9. The system as recited in claim 1, wherein the optical instrument is a spectrometer.

10. A method of evaluating the operational state of an optical instrument, comprising:
obtaining a difference spectrum from differential optical spectra obtained under different illumination conditions of an integrated light source of the optical instrument; and
analyzing the difference spectrum to derive a metric indicative of the operational state.

11. The method as recited in claim 10, wherein the difference spectrum is a test difference spectrum obtained after manufacturing and the analyzing includes comparing the test difference spectrum to a reference difference spectrum obtained during manufacturing.

12. The method as recited in claim 11, wherein the comparing includes thresholding of differences between the test difference spectrum and the reference difference spectrum.

13. The method as recited in claim 11, wherein the comparing includes verifying a range of an average value of a ratio of the test difference spectrum and the reference difference spectrum.

14. The method as recited in claim 11, wherein the comparing includes calculating a correlation coefficient between the test difference spectrum and the reference difference spectrum.

15. The method as recited in claim 11, wherein both the test difference spectrum and the reference difference spectrum provide wavelength information and the comparing includes determining a wavelength calibration shift therebetween by calculating an autocorrelation parameter between the test difference spectrum and the reference difference spectrum.

16. The method as recited in claim 10, further comprising conducting one or more individual functional tests directed to specific sub-subsystems of the optical instrument.

17. The method as recited in claim 10, further comprising generating and sending a readiness or non-readiness state for the optical instrument based on analyzing one of the one or more individual functional tests.

18. The method as recited in claim 10, wherein the optical instrument is a spectrometer.

19. A computer program product having a series of operating instructions stored on a non-transitory computer readable medium that directs the operation of one or more processors when initiated thereby to perform operations comprising:
obtaining a test difference spectrum from differential optical spectra obtained under different illumination conditions of an integrated light source of an optical instrument; and
analyzing the test difference spectrum by comparing the test difference spectrum to a reference difference spectrum, wherein the test difference spectrum is obtained after manufacturing of the optical instrument and the reference difference spectrum is obtained during manufacturing of the optical instrument.

20. A spectrometer, comprising:
an optical sensor;
an integrated light source positioned to illuminate the optical sensor; and
one or more processors that perform operations, the operations including:
performing a functional evaluation of the spectrometer by operating the integrated light source and processing differential optical spectra data that corresponds to the integrated light source being on and the integrated light source being off.
